(19) United States
(12) Patent Application Publication
(10) Pub. No.: US 2015/0278782 A1
(43) Pub. Date: Oct. 1, 2015

(54) DEPOSITING AND WITHDRAWING FUNDS

(71) Applicant: EBAY INC., San Jose, CA (US)

(72) Inventors: Daniel Schatt, San Mateo, CA (US); Peter Amalraj, San Jose, CA (US); Arkady Fridman, Twain Harte, CA (US); Mamta Narain, Fremont, CA (US)

(21) Appl. No.: 14/736,203

(22) Filed: Jun. 10, 2015

Related U.S. Application Data
(63) Continuation of application No. 13/246,443, filed on Sep. 27, 2011.

(51) Int. Cl. G06Q 20/10

(52) U.S. Cl. CPC G06Q 20/1085

(57) ABSTRACT

A user without Internet access or a bank account can fund an online payment provider account by depositing cash or voucher from a third party into a machine or with a person, and entering an account identifier, such as an email or phone number. The user can receive cash through the online payment provider by logging into an account through a machine, entering the amount of cash requested, and receiving a voucher. The user can then insert the voucher into a cash dispensing machine or present the voucher to a person to redeem the voucher for cash or redeem the voucher for store merchandise.

### CROSS REFERENCE TO RELATED APPLICATION

This application claims priority to U.S. application Ser. No. 13/246,443, filed Sep. 27, 2011, which is incorporated herein by reference in its entirety.

### BACKGROUND

1. Field of the Invention

The present invention generally relates to financial transactions, and in particular, to depositing and withdrawing funds.

2. Related Art

Online shopping is becoming more and more popular with consumers, due in large part to convenience. Consumers can purchase items from their home, office, or even their mobile devices. Payments can be handled online as well, such as through payment providers like PayPal, Inc. of San Jose, Calif. Such payment providers process payments between parties and typically offer both security and consumer protection. However, in order to use these services, a consumer is required to have an account with the payment provider, where the user account is funded, debited, or credited as needed by the payment provider.

Funding a user account is typically done by electronically transferring money from a user funding source, such as a bank account, to the account. This can be easily done with an Internet access from a user device.

Problems arise if there is no Internet access or if the user does not have an available funding account, such as a bank account. Without Internet availability, the user may not be able to access the account through the payment provider site. Without a bank account or other suitable funding source, the user is unable to electronically transfer funds even with Internet access. If the user is unable to fund an account, the user may be unable to make a desired purchase, resulting in a lost sale for the merchant and a lost desired purchase for the consumer.

Lack of Internet access or a bank account may also hinder the consumer from retrieving funds. Without the Internet, the consumer may not be able to make a transfer for cash through the payment provider. Without a bank account, the consumer may not be able to reach an available machine or branch to withdraw funds. In such situations, the consumer may be inconvenienced, or worse yet, unable to retrieve cash needed at a specific time.

Therefore, a need exists for users to be able to deposit and withdraw funds even if the user has no Internet connection or a suitable funding source.

### SUMMARY

In accordance with different embodiments, a user deposits cash and/or coins into a machine and enters an identifier deposit the money to an account associated with the identifier. hi one embodiment, the identifier is an email or phone number. The account information is retrieved and the deposited cash is credited to the account. As a result, a user can fund an online payment account easily and quickly, without having to enter any sensitive information, such as a password or PIN. The user may also deposit vouchers or other funding items. In this case, the funding item is converted to a cash value, and that value is credited to the specified account.

According to another embodiment, a user obtains a voucher, coupon, barcode, or the like. from a machine, such as a kiosk. The user may also get the voucher on the user device. The user then takes the voucher (either paper or electronic) to a store or machine, has the voucher read and processed, and receives cash based on the voucher. For example, the user may first access the user's account through a machine or user device, such as by entering a user identifier and password/PIN, entering a desired amount for the voucher, and confirming the request. The voucher is then presented or dispensed to the user for cash redemption.

Thus, users have the ability to add money to and retrieve money from their online accounts through any walk-in location/agent/automated retail kiosk, even when the user does not have access to the Internet.

This idea can be used to not only top up or fund a user's account but to also send money to friends and family. The sender can log in to their payment provider account through a kiosk or other device and enter an email address for another person whose account will be credited. As a result, a user can send money to someone else without accessing the Internet and without a bank account.

These and other features and advantages of the present invention will be more readily apparent from the detailed description of the embodiments set forth below taken in conjunction with the accompanying drawings.

### BRIEF DESCRIPTION OF THE FIGURES

FIG. 1 is a flowchart showing a process for funding an online account according to one embodiment;

FIG. 2 is a flowchart showing a process for receiving cash from an online account according to one embodiment;

FIG. 3 is block diagram of a networked system suitable for implementing the process of FIGS. 1 and 2 according to an embodiment; and

FIG. 4 is a block diagram of a computer system suitable for implementing one or more components in FIG. 3 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

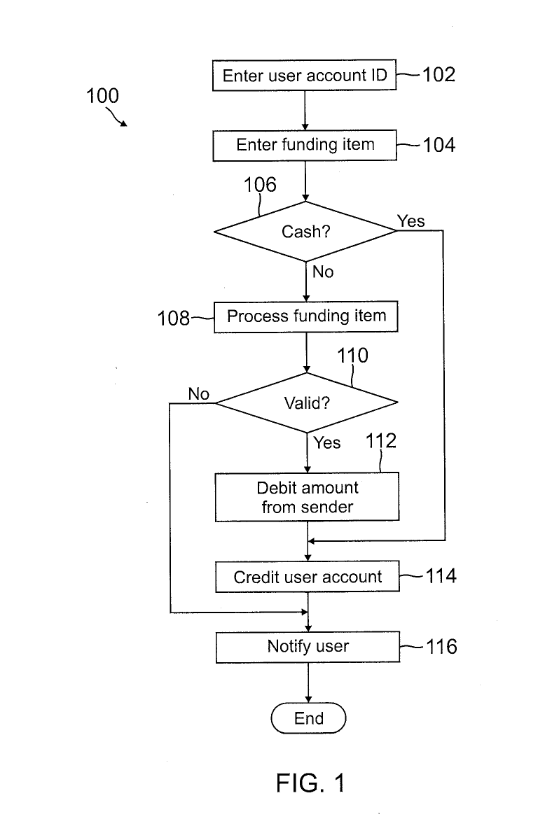

FIG. 1 is a flowchart 100 showing a process for funding an online account using a funding item, according to one embodiment. At step 102, a user enters an account identifier with a value receiving station at step 102. In this embodiment, the value receiving station is a machine, ATM, or kiosk. In another embodiment, the value receiving station includes a teller or agent. The user may enter the identifier, which is associated with a user account with a payment provider, such as PayPal, Inc. of San Jose, Calif., in any suitable way. For example, the user may type in the identifier, speak the identifier, or scan in the identifier. The identifier may be an email address, a phone number, or any other unique identifier that allows the payment provider to locate the user's account with only the identifier. In another embodiment, the user may be requested to be authenticated with additional information, such as, but not limited to, a password, PIN, token, device ID, alone or in combination.

The account identifier is communicated, such as through the machine or by an agent, to the payment provider, which enables the payment provider to locate and access the associated account. In one embodiment, the payment provider may communicate back to the user the name or other information associated with the account, which the user may confirm or not. For example, the user may have inadvertently entered an identifier associated with another account. In that case, the user may fund another person's account by accident. The communication back to the user may be through the same value receiving station or through a user device, such as the user's mobile phone. The payment provider may also check to see if a valid account exists based on the identifier provided and transmit a message to the user if an account does not exist for the user to confirm. In this case the user is expected to create an account after loading the value into the account with the identifier entered. Subsequently, the user can open an account and the money will be available in that account.

After the account identifier is entered and possibly confirmed by the user, the user enters a funding item to fund the account, at step 104. The funding item may be any suitable value item, such as cash, coupons, vouchers, checks, gift cards, etc. Depending on the funding item and/or the value receiving station, the user may enter the funding item in any suitable way. For example, if the value receiving station is a kiosk and the value item is cash, the user may simply insert the cash or deposit coins into an input interface. If the value receiving station is an agent, the user may hand over the funding item to the agent.

If the user is using a funding item other than cash or other similar funding item, as determined at step 106, the funding item is next processed at step 108. The processing may include determining whether the funding item is valid and converting the funding item into a cash or dollar equivalent. In this embodiment, a determination is made, at step 110, whether the funding item is valid. For example, if the funding item is a voucher, the voucher may be processed to determined whether is proper and valid. The voucher may be invalid if it has expired, was issued by a non-recognized entity, is unreadable, is counterfeit, exceeds a limit amount, or fails any fraud/risk analysis.

If the funding item is invalid, the user may be notified at step 116. The user may be notified through the value receiving station or a user device. Once notified, the process may end. Alternatively, the user may be given the option of re-entering or entering a new funding item at step 104, where processing then continues.

If the funding item is valid, as determined at step 110, the amount is debited accordingly at step 112. To determine the details of the debiting, the system may process information from the funding item, such as value and funding source. For example, a voucher may be easily read as having a specific cash value, funded from an identified account with a bank, a payment provider, a credit issuer, or third party. Using this information, the payment provider, either directly or through another entity, may debit the voucher amount from the appropriate account. At this time, the voucher or other funding item may be canceled or otherwise invalidated for any subsequent use. However, if the voucher has any remaining cash value, the voucher may be updated to now allow only the remaining value to be used. In such a case, the user may have requested a funding amount less than the voucher total at an earlier stage in the process.

Next, an appropriate amount is credited to the user account at step 114. The amount may be exactly what was deposited or adjusted up or down, depending on whether any fees were imposed by the payment provider or fees were credited by the payment provider for the funding. For example, the payment provider may charge a fee for the user funding the account in this manner, as this may result in additional hard and/or soft costs for the payment provider. On the other hand, the payment provider may provide certain incentives for funding an account, such as during a certain period of time, for a minimum amount, etc. The incentives can be an additional credit to the account, such as 1% on any funding over $1000.

Once the user account is funded, a notification may be sent, at step 116. The notification can be through the value receiving station, such as a paper receipt or displayed message on a screen. The notification can also be on the user's mobile device, such as via text, email, or voice.

Thus, using the method above, a user can fund an account with a payment provider by simply depositing something of cash value into a machine or handing the item of cash value to a person. There is no need to have a funding source, like a bank account. As a result, consumers without bank accounts may still have the advantages of using an online payment provider for purchases. This can increase sales for merchants, increase consumer satisfaction, and generate additional revenue for the payment provider. Note that in different embodiments, the payment provider may restrict withdrawal of funds from a specified funding source. For example, the withdrawal of funds may be from the payment provider account balance only, with a maximum withdrawal amount periodically, but not to exceed the amount in the account even if the user has a bank account or credit card is attached/linked to the account.

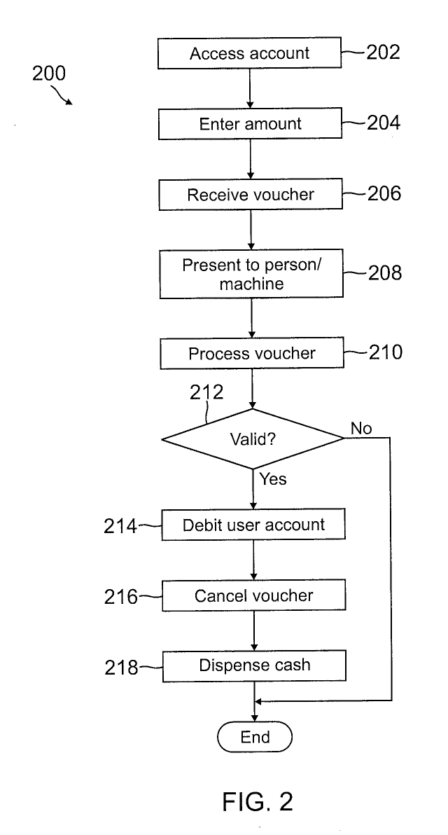

FIG. 2 is a flowchart 200 showing a process for receiving cash from an online account according to one embodiment. At step 202, the user accesses the user's account with the payment provider. In one embodiment, the user logs into an account from a kiosk or other unmanned machine by entering in a user identifier and a password or PIN. The payment provider may also need to be identified if the machine is not solely for the payment provider. The user identifier can be an email address, a user name, a phone number, or the like. In another embodiment, the user logs into the account from a user device, such as a phone, PC, tablet, laptop, or other computing device. This can be through accessing a URL address or App and then entering the requested information. The payment provider then determines whether the user has access or has entered correct information for the account. If the account cannot be accessed, the user may be asked to re-enter certain information.

Once the account is accessed, the payment provider may present the user with various options for the user to select, one of which would be an indication of withdrawing cash from the account. A user selectable screen may be shown on a kiosk display, a user device display, or other suitable display. The user then selects the “withdraw cash” button, link, or option.

Next, the user may be asked to enter an amount of cash to be withdrawn. At step 204, the user enters the desired amount. Entry can through the user entering digits from a keypad or keyboard, verbally, or other means, depending on the input interface. Once the amount is entered, it is communicated to the payment provider for processing.

The payment provider determines if the amount requested can be approved or should be denied. This determination may include fraud/risk analysis, determining whether the amount is within account limits, and determining any restrictions on the account that may apply to the current request. If denied, the user may be requested to enter or re-enter specific information, such as a lower cash withdrawal amount. Even if the user-requested amount exceeds the user's current account balance, the payment provider may still authorize the withdrawal if the user has other funding options available, such as another bank account, a credit card account, etc.

Note that the above may be skipped if the user has already obtained the voucher. This may occur if the user obtained the voucher from a third party (not the payment provider). The third party may have a relationship with or access to the payment provider, such as having an account with the payment provider.

If approved, the payment provider issues and the user receives a voucher at step 206. The voucher contains information that allows the user to redeem the voucher for cash. The voucher can be digital (electronic), such as a display on a user's device, or physical, such as a printed barcode, 2D code (e.g., a QR code), an alpha-numeric identifier, etc., or a plastic card or other physical/tangible medium containing redemption information. For a physical voucher, the user takes the actual voucher from the machine or person. For a digital voucher, the user keeps it stored in the user device (e.g., a smart phone).

When the user is ready to redeem the voucher for cash, the user presents the voucher at the cash-redemption site, at step 208. The cash redemption site can be a manned location, such as at a store, retailer, manned both, etc. The cash redemption site can also be unmanned, such as a cash-dispending kiosk or machine Depending on the form of the voucher and the type of cash-redemption site, the user presents the voucher accordingly. For example, the user may hand the paper voucher to a person, insert the paper voucher into a machine, display the electronic voucher to a person, or have the electronic voucher scanned on the user's device by a person or machine.

The voucher is then processed at step 210. Processing may be by the payment provider or other entity/system. For example, if the voucher is obtained from a third party and the cash-redemption site is associated with (completely or partially) the third party, the third party does the processing for the voucher. Voucher information is communicated to the payment provider, either electronically through a machine or by a person manually entering the voucher (such as typing in a series of numbers/letters) and transmitting the information to the payment provider. Processing may include determining whether the voucher is proper (e.g., not counterfeit), is readable, has not expired, comes from an accepted machine/location/person, and performing any other fraud/risk analysis.

If the voucher is valid, as determined at step 212, the user's account is debited the appropriate amount at step 214. The user's account may be with the payment provider or another party. Note that step 214 may be skipped if the user's account was debited at the time the voucher was issued. In other embodiments, if the voucher was issued by a third party, an account of the third party may be debited, again assuming the account was not debited at the time the voucher was issued.

After the voucher is processed and used, the voucher is canceled at step 216. This may include associating the voucher identifier with a “used” or “canceled” indication, along with the date of use and any other details, such as information about who used the voucher and where. Thus, if the voucher is used again, the system will show a used or partially used voucher and process accordingly.

If the voucher is valid, as determined at step 212, cash is dispensed to the user at step 218. The cash may be dispensed by a machine or handed to the user by a teller or agent. If cash is dispensed by a person, the person may be notified by the payment provider that the voucher is valid and the user can be given the cash. An account of the cash dispenser with the payment provider may be credited in the amount dispensed. Note that steps 214 through 218 may be performed in different orders or combined in one or more steps. Consequently, the user is able to obtain cash without Internet access and/or bank accounts.

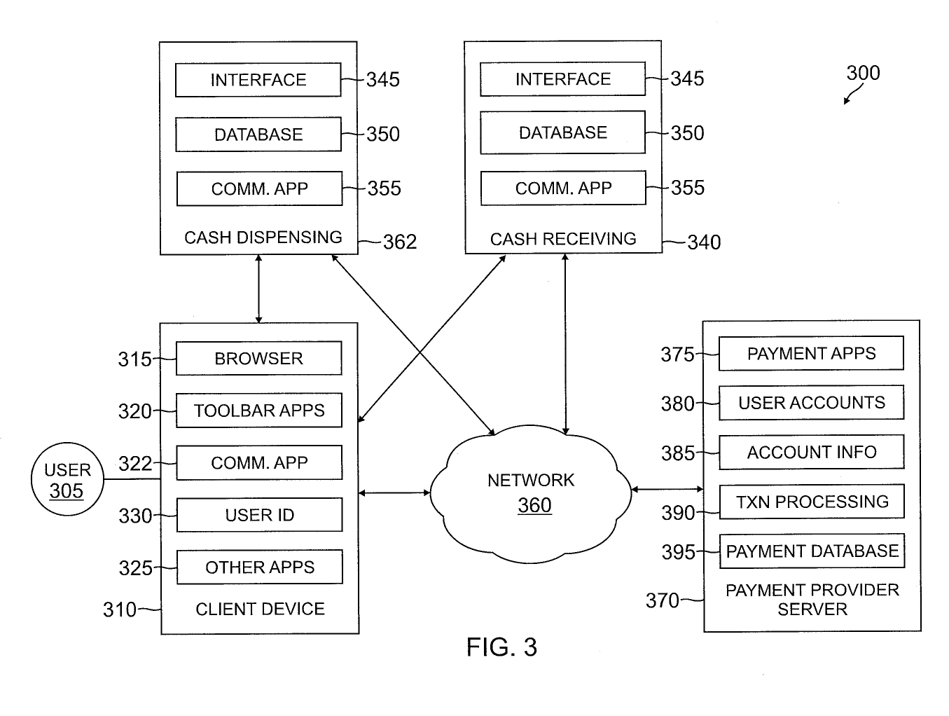

FIG. 3 is a block diagram of a networked system 300 configured to handle a financial transaction between a user and a payment provider, such as described above, in accordance with an embodiment of the invention. System 300 includes a user or client device 310, a cash receiver 340, a cash dispenser 362, and a payment provider server 370 in communication over a network 360. Payment provider server 370 may be maintained by a payment provider, such as PayPal, Inc. of San Jose, Calif. A user 305, who may not have Internet access and/or a bank account, utilizes user device 310 to perform transactions for depositing cash into an account with the payment provider and receiving cash. Cash receiver 340 and cash dispenser 362 may communicate with payment provider servicer 370 over network 360 to effect the transactions as described above. Note that user 305 may interact with cash receiver 340 and cash dispenser 362 directly without user device 310.

User device 310, cash receiver 340, cash dispenser 362, and payment provider server 370 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

Network 360 may be implemented as a single network or a combination of multiple networks. For example, in various embodiments, network 360 may include the Internet or one or more intranets, landline networks, wireless networks, and/or other appropriate types of networks.

User device 310 may be implemented using any appropriate hardware and software configured for wired and/or wireless communication over network 360. For example, in one embodiment, the two user devices may be implemented as a personal computer (PC), a smart phone, personal digital assistant (PDA), laptop computer, and/or other types of computing devices capable of transmitting and/or receiving data, such as an iPad™ from Apple™.

User device 310 may include one or more browser applications 315 which may be used, for example, to provide a convenient interface to permit user 305 to browse information available over network 360. For example, in one embodiment, browser application 315 may be implemented as a web browser configured to view information available over the Internet. User device 310 may also include one or more toolbar applications 320 which may be used, for example, to provide client-side processing for performing desired tasks in response to operations selected by user 305. In one embodiment, toolbar application 320 may display a user interface in connection with browser application 315 as further described herein.

User device 310 may further include other applications 325 as may be desired in particular embodiments to provide desired features to user device 310. For example, other applications 325 may include security applications for implementing client-side security features, programmatic client applications for interfacing with appropriate application programming interfaces (APIs) over network 360, or other types of applications. Applications 325 may also include email, texting, voice and IM applications that allow user 305 to send and receive emails, calls, and texts through network 360, as well as applications that enable the user to make perform transactions through the payment provider as discussed above. User device 310 may include one or more user identifiers 330 which may be implemented, for example, as operating system registry entries, cookies associated with browser application 315, identifiers associated with hardware of user device 310, or other appropriate identifiers, such as used for payment/user/device authentication. In one embodiment, user identifier 330 may be used by a payment service provider to associate user 305 with a particular account maintained by the payment provider as further described herein. A communications application 322, with associated interfaces, enables user device 310 to communicate within system 300. User device 310 may further be used to generate and display vouchers as described above.

Cash receiver 340, in this embodiment, is an unmanned device, such as an ATM or kiosk. Cash receiver 340 may also be operated by or associated with a person. Cash receiver 340 has an interface 345, which may be configured to receive cash or other value items that will be used to fund a user's account. For example, the interface may be a slot that the user can insert the value item into. The interface may also include processing that reads the received value item and determines a value and/or determines that the value item is to be communicated to the payment provider. Furthermore, interface 345 may include an input that enables the user to enter information, such as a user account identifier.

A database 350, such as memory, can store information related to the value item and/or the user. A communication application 355 enables cash receiver 340 to communicate with payment provider server 370 to process the transaction if needed. For example, communication application 355 may transmit value item information and/or user information to the payment provider.

Cash dispenser 362, in this embodiment, is a separate unmanned device, such as an ATM or kiosk. In other embodiments, cash dispenser is the same device as cash receiver 340. In yet another embodiment, cash dispenser 362 is operated by or associated with a person. Here, cash dispenser 362 may have similar applications and modules as cash receiver 340, but is used, in this example, for dispensing cash to user 305.

Cash dispenser 362 has an interface 345, which may be configured to dispense cash or other value items to user 305. For example, the interface may be a slot or opening that dispenses cash or a voucher to the user. The interface may also include processing that generates a voucher for later cash redemption by the user, determines the amount of cash to be dispensed, and/or processes an inserted voucher, as described above. Furthermore, interface 345 may include an input that enables the user to enter information, such as an amount for the voucher.

A database 350, such as memory, can store information related to the value item, voucher, and/or the user. A communication application 355 enables cash dispenser 362 to communicate with payment provider server 370 to process the transaction if needed. For example, communication application 355 may transmit value item information and/or user information to payment provider server 370.

Payment provider server 370 may be maintained, for example, by an online payment service provider which may provide financial services to user 305. In this regard, payment provider server 370 includes one or more payment applications 375 which may be configured to interact with user device 310, cash receiver 340, and/or cash dispenser 362 over network 360 to facilitate funding an account or obtaining cash.

Payment provider server 370 also maintains a plurality of user accounts 380, each of which may include account information 385 associated with individual users. For example, account information 385 may include private financial information of users of devices such as account numbers, passwords, device identifiers, user names, phone numbers, credit card information, bank information, account restrictions, and/or other financial information which may be used to facilitate transactions by user 305. Advantageously, payment application 375 may be configured to interact with cash receiver 340 to fund deposited value into a user account and/or with cash dispenser 362 to authorize cash dispensed to user 305.

A transaction processing application 390, which may be part of payment application 375 or separate, may be configured to receive information from user device 305, cash receiver 350, and/or cash dispenser 362 for processing and storage of data in a payment database 395. Transaction processing application 390 may include one or more applications to process information from user 305 for processing a deposit or cash dispensing as described herein. Payment application 375 may be further configured to determine the existence of and to manage accounts for user 305, as well as create new accounts if necessary, such as the set up, management, and use of vouchers.

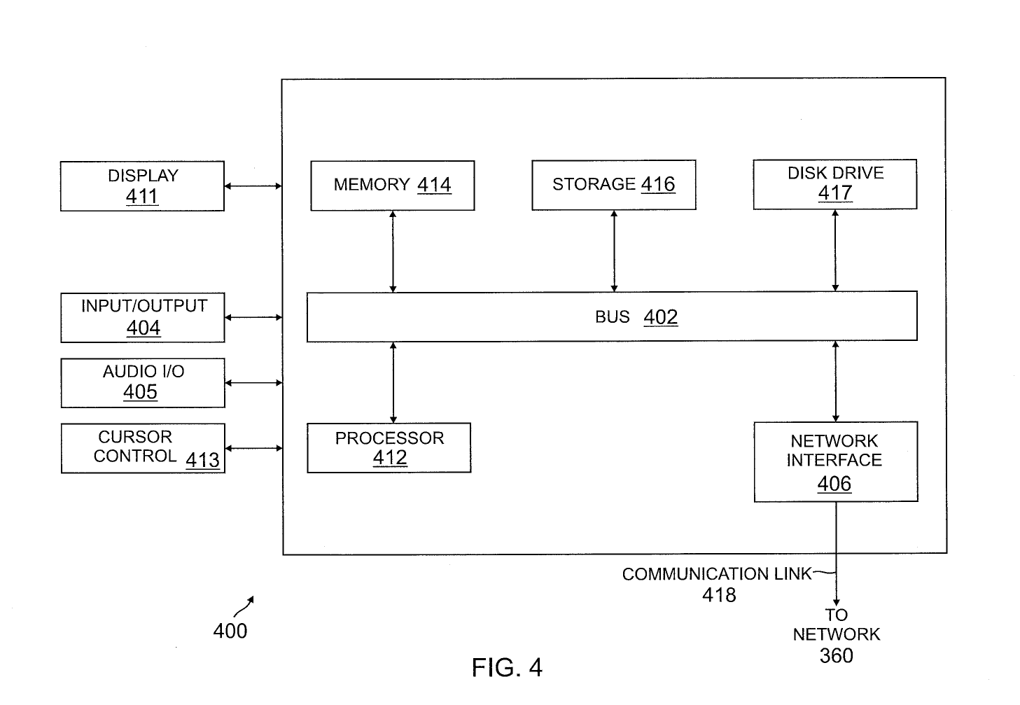

FIG. 4 is a block diagram of a computer system 400 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 or printer and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a cash receiver or dispenser, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. An automated teller machine, comprising:
an input/output component configured to receive a user input identifying a user account;
a communication interface configured to cause a message to be sent to a user device corresponding to the user account and receive a confirmation of a request to deposit funds to the user account;
an item receptacle configured to receive a deposited item; and
a verification component configured to verify value corresponding to the deposited item;
wherein the automated teller machine is configured to cause the value corresponding to the deposited item to be deposited to the user account in response to the communication interface receiving the confirmation and the verification component verifying the value.

2. The automated teller machine of claim 1,
wherein the communication interface is configured to receive the confirmation of the request by receiving information from a payment provider indicating that the payment provider has received an indication from the user device; and
wherein the automated teller machine is distinct from the user device.

3. The automated teller machine of claim 1,
wherein the communication interface is configured to cause the message to be sent to the user device by sending the received information to a payment provider that sends the message to the user device.

4. The automated teller machine of claim 1, wherein the user input identifying the user account is an email address.

5. The automated teller machine of claim 1, wherein the user input identifying the user account is a telephone number corresponding to the user device.

6. The automated teller machine of claim 1, wherein the user input identifying the user account is an identifier used to locate and access the user account without having to enter any sensitive information for authentication.

7. The automated teller machine of claim 1, wherein the value corresponding to the deposited item in the user account is used to process one or more purchases of one or more items.

8. The automated teller machine of claim 1, wherein the communication interface is configured to communicate back to a user the user input identifying the user account for confirmation through the automated teller machine or through the user device.

9. The automated teller machine of claim 1, wherein the deposited item further comprises at least one of cash, a coupon, a voucher, a check, or a gift card.

10. The automated teller machine of claim 1, wherein the automated teller machine is further configured to provide a voucher to a user associated with the user account, wherein the voucher is generated for later redemption by the user.

11. The automated teller machine of claim 10, wherein the voucher is paper or electronic.

12. The automated teller machine of claim 1, wherein the communication interface is configured to cause a notification message to be sent through the automated teller machine or the user device once the value corresponding to the deposited item is deposited to the user account.

13. The automated teller machine of claim 1, wherein the user account is associated with a payment provider, and wherein the payment provider processes the value corresponding to the deposited item for purchases by a user.

14. A method comprising:
receiving, electronically by a processor of a value receiving station, a user input identifying a user account;
causing, electronically by the processor, a message to be sent to a user device corresponding to the user account and receive a confirmation of a request to deposit funds to the user account;
verifying, electronically by the processor, a value corresponding to a deposited item received via an item receptacle of the value receiving station; and
causing, electronically by the processor, the value corresponding to the deposited item to be deposited to the user account in response to receiving the confirmation and verifying the value.

15. The method of claim 14, wherein the receiving the user input identifying the user account further comprises receiving a unique identifier including an email address, or a phone number.

16. The method of claim 14, further comprising receiving, electronically by the processor, the confirmation of the request by receiving information from a payment provider indicating that the payment provider has received an indication from the user device.

17. The method of claim 14, further comprising causing, electronically by the processor, the message to be sent to the user device by sending the received information to a payment provider that sends the message to the user device.

18. The method of claim 14, further comprising communicating with a payment provider that maintains the user account, wherein the payment provider processes the value corresponding to the deposited item for one or more purchases of one or more items.

19. The method of claim 14, wherein the value receiving station further comprises a machine, an automated teller machine, or a kiosk.

20. A non-transitory machine-readable medium comprising a plurality of machine-readable instructions which when executed by one or more processors of a server are adapted to cause the server to perform a method comprising:
receiving a user input identifying a user account;
causing a message to be sent to a user device corresponding to the user account and receive a confirmation of a request to deposit funds to the user account;
verifying a value corresponding to a deposited item received via an item receptacle of the value receiving station; and
causing the value corresponding to the deposited item to be deposited to the user account in response to receiving the confirmation and verifying the value.
